(19) United States
(12) Patent Application Publication
(10) Pub. No.: US 2025/0355917 A1
(43) Pub. Date: Nov. 20, 2025

(54) QUERY GENERATION BASED ON NATURAL LANGUAGE REQUEST AND SCHEMA-RELATED CONTEXT DATA

(71) Applicant: Snowflake Inc., Bozeman, MT (US)

(72) Inventors: Reza Akhavan, Lafayette, CA (US); Christopher T. Nivera, Santa Clara, CA (US); Yusuf Ozuysal, Palo Alto, CA (US); Rajhans Samdani, Belmont, CA (US); Pieter Verhoeven, San Francisco, CA (US)

(21) Appl. No.: 18/668,624

(22) Filed: May 20, 2024

(51) Int. Cl. G06F 16/338; G06F 16/33

(52) U.S. Cl. CPC G06F 16/338; G06F 16/3344

(57) ABSTRACT

Various embodiments described herein provide for systems, methods, devices, instructions, and like for generating a structured language data query based on a natural language request and context data relating to a schema of a data store (e.g., database or the like). In particular, some embodiments use a set of large language models to generate a structured language data query for a data store based on the natural language request and the context data, where the response comprises a structured language data query for a data store, and a natural language explanation of the structured language data query.

### TECHNICAL FIELD

Embodiments described herein relate to data systems and, more particularly, to systems, methods, devices, and instructions for generating a structured language data query based on a natural language request and context data relating to a schema of a data store.

### BACKGROUND

The field of data management and analysis has seen significant advancements with the integration of artificial intelligence (AI) and machine learning (ML) technologies. In particular, the use of natural language processing (NLP) has transformed how users interact with databases, allowing for more intuitive and accessible data querying and analysis. This evolution has led to the development of various tools and systems that facilitate the interaction between users and complex data environments through conversational interfaces.

### BRIEF DESCRIPTION OF THE SEVERAL VIEWS OF THE DRAWINGS

Various ones of the appended drawings merely illustrate various embodiments of the present disclosure and should not be considered as limiting its scope. In the drawings, which are not necessarily drawn to scale, like numerals may describe similar components in different views. To easily identify the discussion of any particular element or act, the most significant digit or digits in a reference number refer to the figure number in which that element is first introduced.

FIG. 1 illustrates an example computing environment comprising a database system in the example form of a network-based database system that includes a structured language data query generator, according to some embodiments of the present disclosure.

FIG. 2 is a block diagram illustrating components of a compute service manager, according to some embodiments of the present disclosure.

FIG. 3 is a block diagram illustrating components of an execution platform, according to some embodiments of the present disclosure.

FIG. 4 and FIG. 5 are flowcharts of example methods for generating a structured language data query based on a natural language question and context data relating to a schema of a data store, according to some embodiments of the present disclosure.

FIG. 6 is a diagram illustrating an example artificial intelligence (AI)-based assistant system, according to some embodiments of the present disclosure.

FIG. 7 is a diagram illustrating an example chain of large language models, according to some embodiments of the present disclosure.

FIG. 8A through FIG. 8I illustrate an example graphical user interface for an artificial intelligence (AI)-based assistant system and example interactions with the example graphical user interface, according to some embodiments of the present disclosure.

FIG. 9A and FIG. 9B illustrate an example graphical user interface for an artificial intelligence (AI)-based assistant system presented within another graphical user interface for a software application environment, according to some embodiments of the present disclosure.

FIG. 10 illustrates an example graphical user interface for receiving customer instructions, according to some embodiments of the present disclosure.

FIG. 11 illustrates a diagrammatic representation of a machine in the form of a computer system within which a set of instructions can be executed for causing the machine to perform any one or more of the methodologies discussed herein, according to some embodiments of the present disclosure.

### DETAILED DESCRIPTION

Reference will now be made in detail to specific embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Recent advancements in the field of database management and querying systems have included the use of NLP technologies to interpret natural language inputs and convert them into structured query language (SQL) commands or commands in other structured languages, enhancements in the graphical user interfaces (GUIs) of database systems that make it easier for users to interact with complex data, and migration of database services to cloud platforms (which offers benefits such as scalability, flexibility, and accessibility). Despite these and other advancements, there are ongoing challenges in enhancing the accuracy of query generation, improving the user experience in interacting with database systems, and maintaining efficient query performance as databases grow in complexity and size.

Various embodiments described herein provide for systems, methods, devices, instructions, and like for generating a structured language data query based on a natural language request and context data relating to a schema of a data store (e.g., database or the like). According to various embodiments, a system receives, in association with a user, a selection of a schema and a natural language request, where the schema selected is within a data store (e.g., database) that the user intends to query, where the natural language request comprises a question (or inquiry) or a command that is expressed in the user's natural language, and where the natural language request is intended to retrieve or manipulate data within the schema. After receiving the natural language request, the system can determine context data to be used in responding to the natural language request. This context data can comprise a set of text from chat history data (e.g., last 15 messages from user's chat history) associated with the user and metadata associated with the selected schema. The metadata associated with the selected schema can be obtained by way of a metadata search component, which can search for the metadata using a query string comprising one or more of user information (e.g., user's role, user's access privileges, user's organization, etc.), a set of text from the chat history data associated with the user, and the natural language request. The chat history data can comprise previous natural language requests, responses, and interactions that the user has had with the system, which can provide insights into the user's preferences, terminology, and typical natural language request patterns. The metadata associated with the schema includes information about the structure of the database, such as table names, column names, data types, relationships between tables, and comments (e.g., table or column comments), which can be useful in accurately interpreting and responding to the natural language request. The metadata can provide semantic understanding of data belonging to the user's organization.

The system can use a set of large language models (LLMs) to generate a response to the natural language request based on the (determined) context data and the natural language request. A large language model used by an embodiment can be trained on vast datasets (e.g., a foundational model) to understand and generate human-like text, enabling them to interpret the user's natural language request and generate appropriate responses. The response generated by the system can comprise a structured language data query (e.g., expressed by a data definition language (DDL), such as structured query language (SQL)) that can be performed (e.g., executed) on a data store (e.g., database) to obtain a query response (e.g., comprising numeric or tabular data) or to modify or add stored data to the data store (per the user's natural language request). The response generated can also comprise a natural language explanation of the structured language data query, where the natural language explanation can explain or detail how the structured language data query operates and what result the structured language data query aims to achieve. The natural language explanation can enhance the user's understanding of the interaction between the user's natural language request and the data store operations to be performed by the structured language data query provided in the response.

For some embodiments, metadata associated with a schema is associated with an organization that is associated with a user. Depending on the embodiment, metadata can comprise a description (e.g., name, description of structure, description of entity relationships, description of data types) of data store or a table, a view, or a column stored on a data store. One or more data stores (e.g., database), tables, views, or columns described in metadata (e.g., identified by a metadata search component) can represent ones that are relevant to responding to a natural language request (e.g., relevant according to a query string generated based on the natural language request user's chat history and possibly other information). The descriptions provided in metadata associated with a schema can include one or more natural language descriptions of contents, one or more data stores, tables, or columns. By using metadata that describes relevant data stores, tables, views, columns and the like, an embodiment described herein can filter down to the generated response that is most relevant to the user's natural language request. Additionally, metadata can comprise a comment, a tag, a structured language data query history associated with the user, or user feedback associated with the user.

According to some embodiments, a data system that implements structured language data query generation as described herein can be integrated into one or more downstream software applications (e.g., data worksheet or data notebook software application), which can allow for an AI-based assistant (also referred to herein as a copilot) to be implemented or supported within the one or more downstream software applications. Some embodiments provide an application programming interface (API), such as a REST API, configured to facilitate the interaction between one or more front-end applications, and a backend data service that implements structured language data query generation as described herein. In this way, the API can enable a front-end or downstream software application to be enabled with an AI-based assistant described herein. An API of some embodiments permits the development of a flexible, user-friendly interface that can communicate with complex data backends. Additionally, some embodiments are integrated into an existing software application or tool as an AI-based assistant component or tool, which can be presented, for example, via a chat interface (e.g., chat graphical user interface) in the software application/tool. For example, through a chat interface, a user can ask an AI-based assistant component/tool to respond to one or more natural language questions based on at least one selected data store table, data store view, or schema (e.g., the AI-based assistant can map the selected database table, database view, or schema to corresponding semantic data, and generate one or more SQL queries based on a natural language question and the corresponding semantic data, which user can choose to add (e.g., insert) in or run within a context inside the existing software application/tool but that is external to the AI-based assistant component/tool.

Use of various embodiments can enable users, who may or may not be proficient in structured query languages, to interact effectively or more easily with complex databases by using natural language, making data querying more accessible and intuitive. For example, various embodiments described herein implement or support an artificial intelligence (AI)-based assistant that can assist a technical user (such as data analysts or SQL developers) in common coding tasks (e.g., writing SQL queries or Python code within a software coding environment, such as an Integrated Development Environment (IDE)). As another example, various embodiments described herein implement or support an AI-based assistant that assists a technical or non-technical user in exploring datasets (e.g., exploration by data analyst or data scientist) stored in one or more data stores or assists the technical/non-technical user in answering questions about stored documentation. The system's use of context data can ensure that the responses are accurate, tailored to historical interactions of individual users, and tailored to a schema's metadata, thereby improving the relevance and precision of the generated structured language data queries and explanations, which in turn can improve overall user experience.

As used herein, a natural language request from a user can comprise a natural language command to be performed on a data store, or a natural language question (e.g., a business or non-business question) to be answered by data (e.g., tabular or numerical data) stored on a data store.

As used herein, a database schema (or schema) can comprise a logical description that defines how data is stored and organized within a data store, such as a database. A schema can define, for example, an arrangement of tables, fields (e.g., columns), relationships, and other elements. While a schema can serve as a blueprint that outlines how data is stored and organized within the database, a schema usually does not store the data itself. As used herein, a database can store and manage data in accordance with a schema. A database can include one or more schemas that define different ways data is organized and stored within the database. As used herein, a dataset can refer to a data point or data records within a database or datastore.

As used herein, a large language model (LLM) can include, without limitation, a GPT model (e.g., GPT-4), a Llama model (e.g., Llama-2), a Mistral model (e.g., Mistral Large), a Claude model (e.g., Claude 3) or another type of generative model (e.g., a proprietary or tailored, generative pre-trained transformer). Generally, a LLM comprises one or more transformer neural networks, which can be configured (e.g., trained) for general-purpose language generation or another natural language processing task.

Reference will now be made in detail to various embodiments of the present disclosure, examples of which are illustrated in the appended drawings. The present disclosure may, however, be embodied in many different forms and should not be construed as being limited to the examples set forth herein.

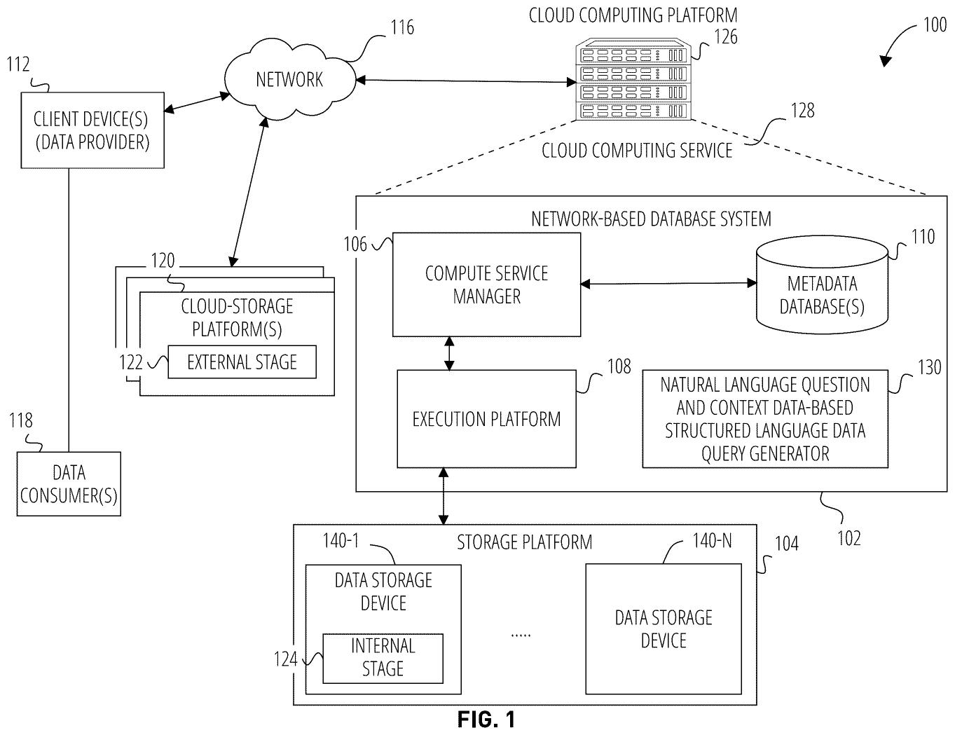

FIG. 1 illustrates an example computing environment 100 comprising a database system in the example form of a network-based database system 102 that includes a structured language data query generator 130, according to some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform. For example, in some embodiments, the computing environment 100 may include a cloud computing platform 126 with the network-based database system 102, and a storage platform 104 (also referred to as a cloud storage platform). The cloud computing platform 126 provides computing resources and storage resources that may be acquired (purchased) or leased and configured to execute applications and store data.

The cloud computing platform 126 may host a cloud computing service 128 that facilitates storage of data on the cloud computing platform 126 (e.g., data management and access) and analysis functions (e.g., SQL queries, analysis), as well as other processing capabilities (e.g., configuring replication group objects as described herein). The cloud computing platform 126 may include a three-tier architecture: data storage (e.g., storage platforms 104), an execution platform 108 (e.g., providing query processing), and a compute service manager 106 providing cloud services.

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURER, GOOGLE CLOUD PLATFORM™, and/or the like. The customer's servers and cloud-storage platforms are both examples of what a given customer could use as what is referred to herein as an external storage location. The cloud computing platform 126 could also use a cloud-storage platform as what is referred to herein as an internal storage location concerning the data platform.

From the perspective of the network-based database system 102 of the cloud computing platform 126, one or more files that are stored at one or more storage locations are referred to herein as being organized into one or more of what is referred to herein as either “internal stages” or “external stages.” Internal stages (e.g., internal stage 124) are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 126 is in communication with the storage platforms 104 and cloud-storage platforms 120 (e.g., AWS®, Microsoft Azure Blob Storage®, or Google Cloud Storage). The network-based database system 102 is a network-based system used for reporting and analysis of integrated data from one or more disparate sources including one or more storage locations within the storage platform 104. The storage platform 104 comprises a plurality of computing machines and provides on-demand computer system resources such as data storage and computing power to the network-based database system 102.

The network-based database system 102 comprises a compute service manager 106, an execution platform 108, and one or more metadata databases 110. The network-based database system 102 hosts and provides data reporting and analysis services to multiple client accounts.

The compute service manager 106 coordinates and manages operations of the network-based database system 102. The compute service manager 106 also performs query optimization and compilation as well as managing clusters of computing services that provide compute resources (also referred to as “virtual warehouses”). The compute service manager 106 can support any number of client accounts such as end-users providing data storage and retrieval requests, system administrators managing the systems and methods described herein, and other components/devices that interact with compute service manager 106.

The compute service manager 106 is also in communication with a client device 112. The client device 112 corresponds to a user of one of the multiple client accounts supported by the network-based database system 102. A user may utilize the client device 112 to submit data storage, retrieval, and analysis requests to the compute service manager 106. Client device 112 (also referred to as remote computing device or user client device 112) may include one or more of a laptop computer, a desktop computer, a mobile phone (e.g., a smartphone), a tablet computer, a cloud-hosted computer, cloud-hosted serverless processes, or other computing processes or devices may be used (e.g., by a data provider) to access services provided by the cloud computing platform 126 (e.g., cloud computing service 128) by way of a network 116, such as the Internet or a private network. A data consumer 118 can use another computing device to access the data of the data provider (e.g., data obtained via the client device 112).

In the description below, actions are ascribed to users, particularly consumers and providers. Such actions shall be understood to be performed concerning client device (or devices) 112 operated by such users. For example, a notification to a user may be understood to be a notification transmitted to the client device 112, input or instruction from a user may be understood to be received by way of the client device 112, and interaction with an interface by a user shall be understood to be interaction with the interface on the client device 112. In addition, database operations (joining, aggregating, analysis, etc.) ascribed to a user (consumer or provider) shall be understood to include performing such actions by the cloud computing service 128 in response to an instruction from that user.

The compute service manager 106 is also coupled to one or more metadata databases 110 that store metadata about various functions and aspects associated with the network-based database system 102 and its users. For example, a metadata database 110 may include a summary of data stored in remote data storage systems as well as data available from a local cache. Additionally, a metadata database 110 may include information regarding how data is organized in remote data storage systems (e.g., the cloud storage platform 104) and the local caches. Information stored by a metadata database 110 allows systems and services to determine whether a piece of data needs to be accessed without loading or accessing the actual data from a storage device. In some embodiments, metadata database 110 is configured to store account object metadata (e.g., account objects used in connection with a replication group object).

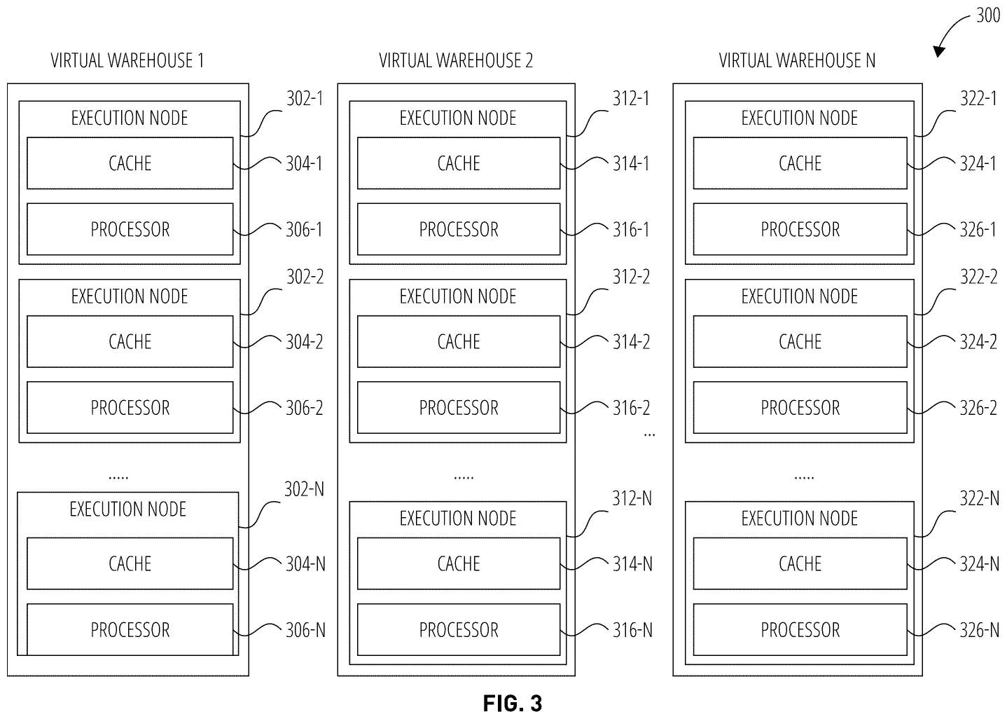

The compute service manager 106 is further coupled to the execution platform 108, which provides multiple computing resources that execute various data storage and data retrieval tasks. As illustrated in FIG. 3, the execution platform 108 comprises a plurality of compute nodes. The execution platform 108 is coupled to storage platform 104 and cloud-storage platforms 120. The storage platform 104 comprises multiple data storage devices 140-1 to 140-N. In some embodiments, the data storage devices 140-1 to 140-N are cloud-based storage devices located in one or more geographic locations. For example, the data storage devices 140-1 to 140-N may be part of a public cloud infrastructure or a private cloud infrastructure. The data storage devices 140-1 to 140-N may be hard disk drives (HDDs), solid-state drives (SSDs), storage clusters, Amazon S3™ storage systems, or any other data-storage technology. Additionally, the cloud-storage platforms 104 may include distributed file systems (such as Hadoop Distributed File Systems (HDFS)), object storage systems, and the like. In some embodiments, at least one internal stage 124 may reside on one or more of the data storage devices 140-1 to 140-N, and at least one external stage 122 may reside on one or more of the cloud-storage platforms 120.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-networks) coupled to one another. In alternative embodiments, these communication links are implemented using any type of communication medium and any communication protocol.

The compute service manager 106, metadata database(s) 110, execution platform 108, and storage platform 104, are shown in FIG. 1 as individual discrete components. However, each of the compute service manager 106, metadata database(s) 110, execution platform 108, and storage platform 104 may be implemented as a distributed system (e.g., distributed across multiple systems/platforms at multiple geographic locations). Additionally, each of the compute service manager 106, metadata database(s) 110, execution platform 108, and storage platform 104 can be scaled up or down (independently of one another) depending on changes to the requests received and the changing needs of the network-based database system 102. Thus, in the described embodiments, the network-based database system 102 is dynamic and supports regular changes to meet the current data processing needs.

During a typical operation, the network-based database system 102 processes multiple jobs determined by the compute service manager 106. These jobs are scheduled and managed by the compute service manager 106 to determine when and how to execute the job. For example, the compute service manager 106 may divide the job into multiple discrete tasks and may determine what data is needed to execute each of the multiple discrete tasks. The compute service manager 106 may assign each of the multiple discrete tasks to one or more nodes of the execution platform 108 to process the task. The compute service manager 106 may determine what data is needed to process a task and further determine which nodes within the execution platform 108 are best suited to process the task. Some nodes may have already cached the data needed to process the task and, therefore, be a good candidate for processing the task. Metadata stored in a metadata database 110 assists the compute service manager 106 in determining which nodes in the execution platform 108 have already cached at least a portion of the data needed to process the task. One or more nodes in the execution platform 108 process the task using data cached by the nodes and, if necessary, data retrieved from the storage platform 104. It is desirable to retrieve as much data as possible from caches within the execution platform 108 because the retrieval speed is typically much faster than retrieving data from the storage platform 104.

As shown in FIG. 1, the cloud computing platform 126 of the computing environment 100 separates the execution platform 108 from the storage platform 104. In this arrangement, the processing resources and cache resources in the execution platform 108 operate independently of the data storage devices 140-1 to 140-N in the storage platform 104. Thus, the computing resources and cache resources are not restricted to specific data storage devices 140-1 to 140-N. Instead, all computing resources and all cache resources may retrieve data from, and store data to, any of the data storage resources in the storage platform 104.

As also shown, the network-based database system 102 comprises a natural language question and context data-based structured language data query generator 130 (hereafter, referred to as the structured language data query generator 130), which is configured to implement generation of a structured language data query based on a natural language request and context data relating to a schema of a data store (e.g., database or the like) as described herein, where the data store can be stored on the storage platform 104.

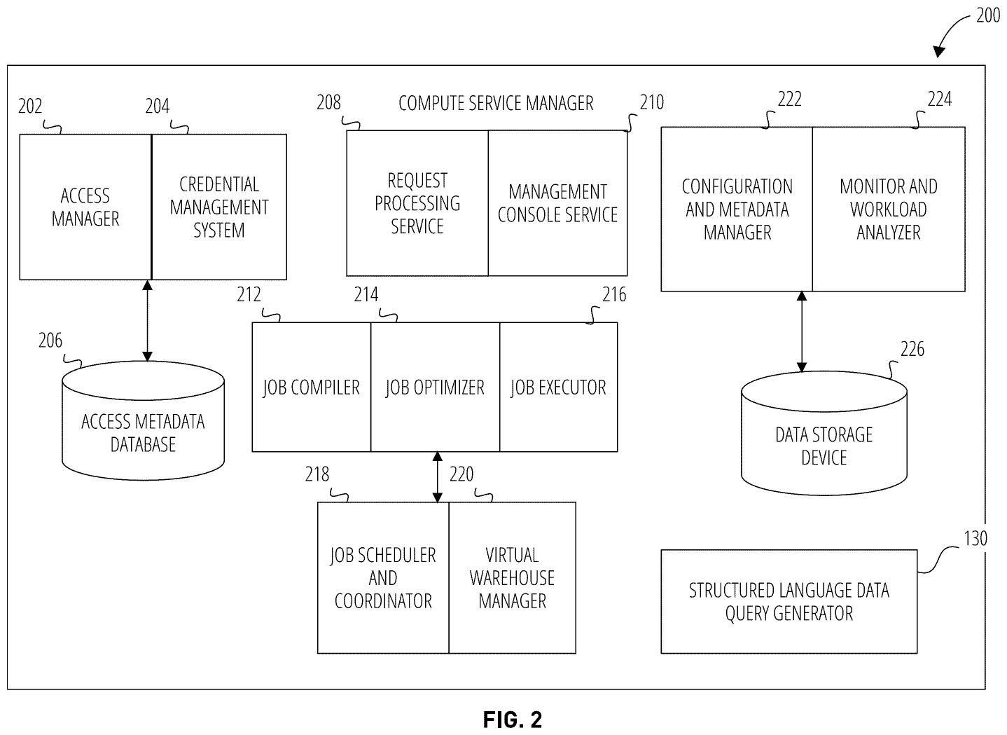

FIG. 2 is a block diagram 200 illustrating components of the compute service manager 106, in accordance with some embodiments of the present disclosure. As shown in FIG. 2, the compute service manager 106 includes an access manager 202 and a credential management system 204 coupled to access access metadata database 206, which is an example of the metadata database(s) 110.

Access manager 202 handles authentication and authorization tasks for the systems described herein. The credential management system 204 facilitates use of remote stored credentials to access external resources such as data resources in a remote storage device. As used herein, the remote storage devices may also be referred to as “persistent storage devices” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data can be stored in a cache within the execution platform 108 or in a data storage device in storage platform 104.

A management console service 210 supports access to various systems and processes by administrators and other system managers. Additionally, the management console service 210 may receive a request to execute a job and monitor the workload on the system.

The compute service manager 106 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 106.

A job scheduler and coordinator 218 sends received jobs to the appropriate services or systems for compilation, optimization, and dispatch to the execution platform 108. For example, jobs can be prioritized and then processed in that prioritized order. In an embodiment, the job scheduler and coordinator 218 determines a priority for internal jobs that are scheduled by the compute service manager 106 with other “outside” jobs such as user queries that can be scheduled by other systems in the database but may utilize the same processing resources in the execution platform 108. In some embodiments, the job scheduler and coordinator 218 identifies or assigns particular nodes in the execution platform 108 to process particular tasks. A virtual warehouse manager 220 manages the operation of multiple virtual warehouses implemented in the execution platform 108. For example, the virtual warehouse manager 220 may generate query plans for executing received queries.

Additionally, the compute service manager 106 includes a configuration and metadata manager 222, which manages the information related to the data stored in the remote data storage devices and in the local buffers (e.g., the buffers in execution platform 108). The configuration and metadata manager 222 uses metadata to determine which data files need to be accessed to retrieve data for processing a particular task or job. A monitor and workload analyzer 224 oversees processes performed by the compute service manager 106 and manages the distribution of tasks (e.g., workload) across the virtual warehouses and execution nodes in the execution platform 108. The monitor and workload analyzer 224 also redistributes tasks, as needed, based on changing workloads throughout the cloud computing platform 126 and may further redistribute tasks based on a user (e.g., “external”) query workload that may also be processed by the execution platform 108. The configuration and metadata manager 222 and the monitor and workload analyzer 224 are coupled to a data storage device 226. Data storage device 226 in FIG. 2 represents any data storage device within the storage platform 104. For example, data storage device 226 may represent buffers in execution platform 108, storage devices in cloud storage platform 104, or any other storage device.

As described in embodiments herein, the compute service manager 106 validates all communication from an execution platform (e.g., the execution platform 108) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 302-1) may need to communicate with another execution node (e.g., execution node 302-2), and should be disallowed from communicating with a third execution node (e.g., execution node 312-1) and any such illicit communication can be recorded (e.g., in a log or other location). Also, the information stored on a given execution node is restricted to data relevant to the current query and any other data is unusable, rendered so by destruction or encryption where the key is unavailable.

FIG. 3 is a block diagram 300 illustrating components of the execution platform 108, in accordance with some embodiments of the present disclosure. As shown in FIG. 3, the execution platform 108 includes multiple virtual warehouses, including virtual warehouse 1, virtual warehouse 2, and virtual warehouse N. Each virtual warehouse includes multiple execution nodes that each include a data cache and a processor. The virtual warehouses can execute multiple tasks in parallel by using the multiple execution nodes. As discussed herein, the execution platform 108 can add new virtual warehouses and drop existing virtual warehouses in real-time based on the current processing needs of the systems and users. This flexibility allows the execution platform 108 to quickly deploy large amounts of computing resources when needed without being forced to continue paying for those computing resources when they are no longer needed. All virtual warehouses can access data from any data storage device (e.g., any storage device in storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer useful.

Each virtual warehouse is capable of accessing any of the data storage devices 140-1 to 140-N shown in FIG. 1. Thus, the virtual warehouses are not necessarily assigned to a specific data storage device 140-1 to 140-N and, instead, can access data from any of the data storage devices 140-1 to 140-N within the storage platform 104. Similarly, each of the execution nodes shown in FIG. 3 can access data from any of the data storage devices 140-1 to 140-N. In some embodiments, a particular virtual warehouse or a particular execution node can be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse N includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternate embodiments may include execution nodes containing any number of processors and any number of caches. Additionally, the caches may vary in size among the different execution nodes. The caches shown in FIG. 3 store, in the local execution node, data that was retrieved from one or more data storage devices in storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor intensive. Similarly, an execution node may be assigned more cache resources if the tasks performed by the execution node require a larger cache capacity.

Although virtual warehouses 1, 2, and N are associated with the same execution platform 108, the virtual warehouses can be implemented using multiple computing systems at multiple geographic locations. For example, virtual warehouse 1 can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse can be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 108 is also fault tolerant. For example, if one virtual warehouse fails, that virtual warehouse is quickly replaced with a different virtual warehouse at a different geographic location. A particular execution platform 108 may include any number of virtual warehouses. Additionally, the number of virtual warehouses in a particular execution platform is dynamic, such that new virtual warehouses are created when additional processing and/or caching resources are needed. Similarly, existing virtual warehouses can be deleted when the resources associated with the virtual warehouse are no longer useful.

In some embodiments, the virtual warehouses may operate on the same data in storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance.

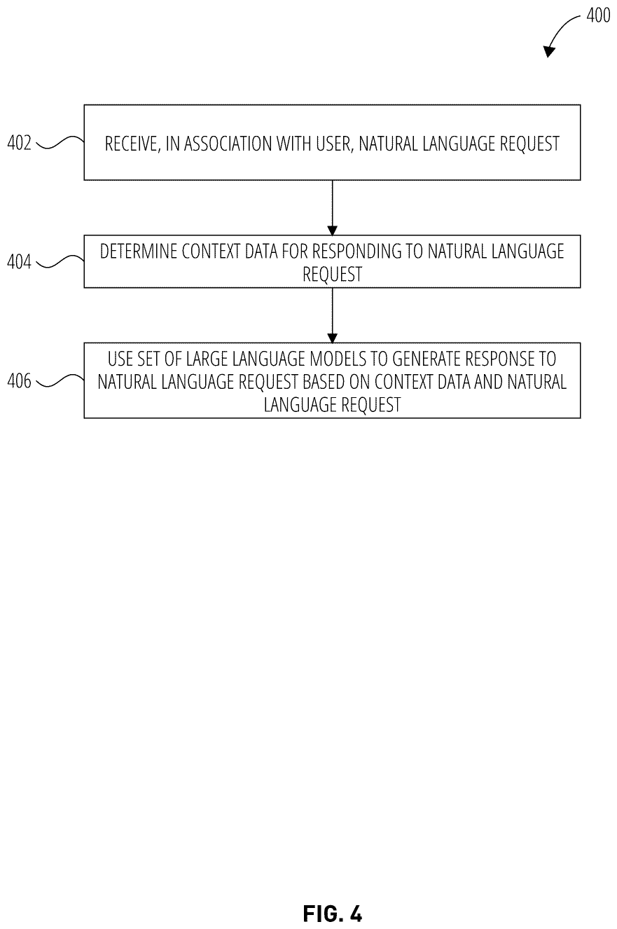

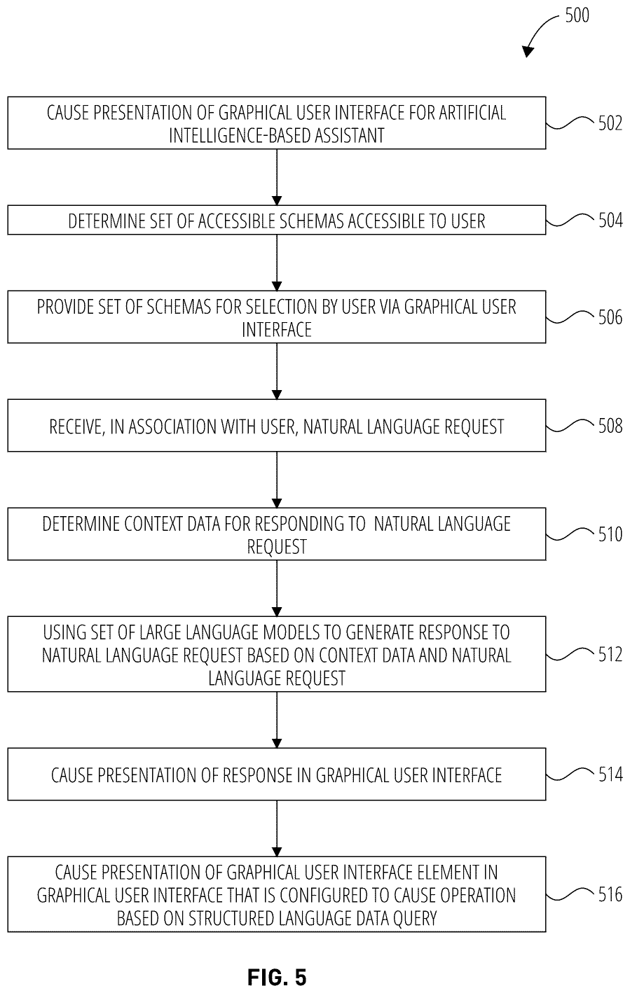

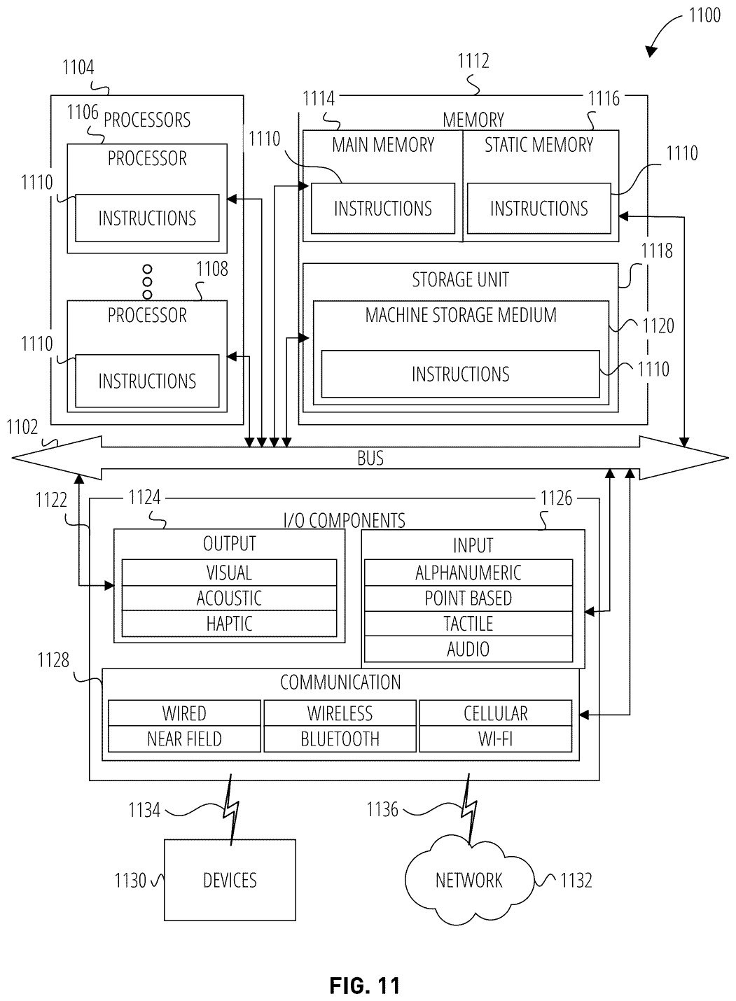

FIG. 4 and FIG. 5 are flowcharts of example methods 400, 500 for generating a structured language data query based on a natural language question and context data relating to a schema of a data store, according to some embodiments of the present disclosure. Any of methods 400, 500 may be embodied in computer-readable instructions for execution by one or more hardware components (e.g., one or more processors) such that the operations of any of methods 400, 500 can be performed by components of the structured language data query generator 130 or the network-based database system 102, such as a network node (e.g., the structured language data query generator 130 executing on a network node of the compute service manager 106) or a computing device (e.g., client device 112), one or both of which may be implemented as machine 1100 of FIG. 11 performing the disclosed functions. Accordingly, methods 400, 500 are described below, by way of example with reference thereto. However, it shall be appreciated that any of methods 400, 500 may be deployed on various other hardware configurations and is not intended to be limited to deployment within the network-based database system 102.

At operation 402, a hardware processor (e.g., implementing the structured language data query generator 130) receives, in association with a user, a natural language request. Additionally, at operation 402, the hardware processor can receive, in association with the user, a selection of a schema. Depending on the embodiment, the selection of the schema can be performed by a user (e.g., a user entering the selection via a graphical user interface for an artificial intelligence-based assistant) or, alternatively, can be automatically performed by a process that selects the schema based on the natural language request (e.g., based on the natural language request). Where the schema is automatically selected based on the natural language request, a user would not need to perform or otherwise provide a selection of the schema.

During operation 404, the hardware processor (e.g., implementing the structured language data query generator 130) determines (e.g., generates or identifies) context data for responding to the natural language request. For some embodiments, the context data comprises metadata associated with the schema (specified by the selection). Additionally, for some embodiments, the context data comprises a set of text from chat history data associated with the user (e.g., the last 15 messages from user's chat with the AI-based assistant). According to some embodiments, operation 404 comprises performing a search (e.g., using a search component), on a metadata data store, for the metadata associated with the schema, where the search can be performed using a query string, and receiving a result to the search, where the result comprises the metadata. The query string can comprise one or more of: the natural language request; a set of text from the chat history data (e.g., a concatenated list of chat text or past messages); information from the schema; or information regarding the user (e.g., user's username, role, organization, privileges, access, etc.). The search can be facilitated by a search component, such as a catalog search service, which can provide relevant table names and relevant columns based on a query string. The search component can enable an embodiment to operate in databases and schemas with large numbers of tables, which would otherwise be challenging to operate in given the finite size of the context window in the underlying one or more LLMs. The search component can be accessed, for example, by way of an application programming interface (API) (e.g., which can receive a query string which can receive a query string, identification of the schema as search scope, at least some portion of chat history, or some combination thereof). The search component can search both stored metadata (e.g., on a metadata data store) and one or more stored documents (e.g., documentation for a data system).

Depending on the embodiment, the metadata can comprise information (e.g., name, description of structure, data types, entity relationships, etc.) regarding at least one of: a data store; one or more tables on the data store and relevant to the query string; one or more columns on the data store and relevant to the query string; or one or more views on the data store and relevant to the query string. Metadata can comprise a comment (e.g., user comment), which can be associated with at least one data store, table, view or column identified as being relevant to the query string. A user comment can comprise an annotation added to an object on a data platform, which can include a user object, a role object, a data warehouse object, a database object, a table object, or a column object. Metadata can comprise a tag, which can be associated with at least one data store, table, view or column identified as being relevant to the query string. A tag can be associated with an object on a data platform and permit a user to monitor sensitive data for compliance, discovery, protection, or resource usage use cases (e.g., through either a centralized or decentralized data governance management approach).

For some embodiments, the context data comprises a set of sample values for one or more columns described by the schema or for one or more columns of one or more elements described by the schema, such one or more tables or one or more views identified in the metadata provided by the search operation. The sample values of columns can comprise performing a SHOW SQL query to fetch all tables or views in the schema accessible to the user, performing a SQL query to fetch the sample values from the fetched tables or views, and filtering down the results to the relevant tables and columns identified in the metadata provided by the search operation.

For some embodiments, the context data comprises a structured language data query history associated with the user. In this way, the user's historical queries can be used as a predictor for structured language data queries that the user will want to write in the future. Additionally, for some embodiments, the context data comprises user feedback data associated with the user. The user feedback data can comprise, for example, feedback that the user provides as the user interacts (e.g., converses) with an AI-based assistant, which can include positive or negative feedback indicators the user provides in connection with a prior response generated by the AI-based assistant. Some embodiments identify and extract this user feedback and generate a repository that contains all the feedback the user provides over time.

For some embodiments, the context data comprises information from verified query repository data (e.g., stored on a verified query repository accessible to the user), where the verified query repository data comprises one or more individual structured language queries paired with natural language descriptions of the individual structured language queries. A user (or the user's organization) can build and maintain a repository of “verified structured language data queries” for the user's (or the organization's use), where each of the verified structured language data queries has a clear natural language description that has been submitted by the user. According to some embodiments, a set of workflows is implemented that permits one or more users (e.g., of an organization) to submit verified structured language data queries to a repository (e.g., associated with the organization). For instance, a user can be able to add a verified structured language data query from a conversation with an AI-based assistant, or directly from a structured language data query history. In the course of adding a verified structured language data query, some embodiments can distill a prior conversation into a natural language request (e.g., natural language question) to pair with a structured language data query or include any relevant feedback that a user had in the course of the conversation as an attachment to the verified structured language data query. The natural language description-structured language data query pairs stored in the repository can encode a variety of information (e.g., organizational knowledge) that can be used as context data for a structured language data query generator as described herein.

For some embodiments, the context data comprises a set of custom instructions or pre-instructions provided by the user. Through the set of custom instructions or pre-instructions, the user can share a set of preferences or specific knowledge (e.g., business knowledge) with the structured language data query generator, which the structured language data query generator can consider (as context) during generation of one or more subsequent responses for the user.

For some embodiments, the context data comprises auto-generated metadata, which can include automatically generated data classification information (e.g., extracted from scans of user data and metadata). The data classification information can comprise a data description of the data content, detailed data format, and variant column schema. Auto-generated metadata can also include data describing a top X number of distinct values for each column of a relevant table or view, which can be used as sample data by the structured language data query generator.

For some embodiments, the context data comprises a set of curated views (e.g., curated by one or more users in an organization). An individual view in the set of curated views can use descriptive and easy-to-understand names for their columns (e.g., the names based on business and data taxonomy likely to be used while using an AI-based assistant), comprise columns having appropriate data type, define commonly used metrics/expressions as new columns, and capture common or complex joins.

For some embodiments, the context data comprises context information provided by a software application external to the AI-based assistant. For example, where the AI-based assistant is invoked and displayed within a software application environment, the software application environment can provide context information (e.g., “product surface” context), such as content (e.g., content data from a data worksheet or data notebook).

For operation 406, the hardware processor (e.g., implementing the structured language data query generator 130) uses a set of large language models to generate a response to the natural language request based on the context data and the natural language request. For some embodiments, the context data and the natural language request are used as input to the set of large language models to generate the response. For some embodiments, the response comprises a structured language data query for (e.g., SQL query configured for execution on) a data store (e.g., database), and a natural language explanation of the structured language data query. For various embodiments, the set of large language models comprises a chain of large language models (e.g., two or more large language models), where a first large language model of the chain of large language models generates a first output based on a first input (e.g., first prompt) that comprises the natural language request and the context data, and where a second large language model of the chain of large language models generates a second output based on a second input (e.g., second prompt) that comprises the natural language request and the first output from the first large language model. The second large language model can receive at least a portion of the context data, additional context data (e.g., determined specifically for the second large language model), or a combination of both. An individual large language model in the set of large language models can receive, as input, a set of instructions specific to the individual large language model; the set of instructions can instruct the individual large language model to perform its intended function/purpose within the set of large language models.

Referring now to FIG. 5, at operation 502, a hardware processor (e.g., implementing the structured language data query generator 130) causes presentation of a graphical user interface for an artificial intelligence-based assistant. For some embodiments, the graphical user interface for the artificial intelligence-based assistant is presented within a software application environment (e.g., IDE), where the context data can comprise information regarding a current context of the software application environment (e.g., current data content being displayed in graphical user interface of the software application environment). For some embodiments, the selection of the schema is received from the user by the graphical user interface, and the natural language request is received from the user by the graphical user interface.

At operation 504, the hardware processor (e.g., implementing the structured language data query generator 130) determines a set of accessible schemas accessible to the user. For operation 506, the hardware processor (e.g., implementing the structured language data query generator 130) provides the set of accessible schemas for selection by the user via the graphical user interface, where the selection of the schema (e.g., via the graphical user interface) is selected from the set of accessible schemas.

After operation 506, operations 508 through 512 are performed. For some embodiments, operations 508, 510, 512 are respectively similar to operations 402, 404, 406 of method 400 described and illustrated with respect to FIG. 4.

At operation 514, the hardware processor (e.g., implementing the structured language data query generator 130) causes presentation of the response in the graphical user interface of the AI-based assistant and, at operation 516, the hardware processor (e.g., implementing the structured language data query generator 130) causes presentation of a graphical user interface element (e.g., graphical user interface button) in the graphical user interface of the AI-based assistant. For some embodiments, the graphical user interface element is configured to cause, upon selection of the graphical user interface element by the user: execution of the structured language data query on the data store; and display of a query result in the graphical user interface, where the query result is received in response to the execution of the structured language data query.

For various embodiments, the graphical user interface for the artificial intelligence-based assistant is presented as a first graphical user interface within a software application environment. A graphical user interface element (presented in the first graphical user interface) can be configured to cause, upon selection of the graphical user interface element by the user, insertion of the structured language data query from the response to a second graphical user interface of the software application environment, where the second graphical user interface is external to the first graphical user interface of the artificial intelligence-based assistant. Additionally or alternatively, a graphical user interface element (presented in the first graphical user interface) can be configured to cause, upon selection of the graphical user interface element by the user: execution of the structured language data query on the data store; and display of a query result in a second graphical user interface of the software application environment, where the second graphical user interface is external to the first graphical user interface of the artificial intelligence-based assistant, and where the query result is received in response to the execution of the structured language data query.

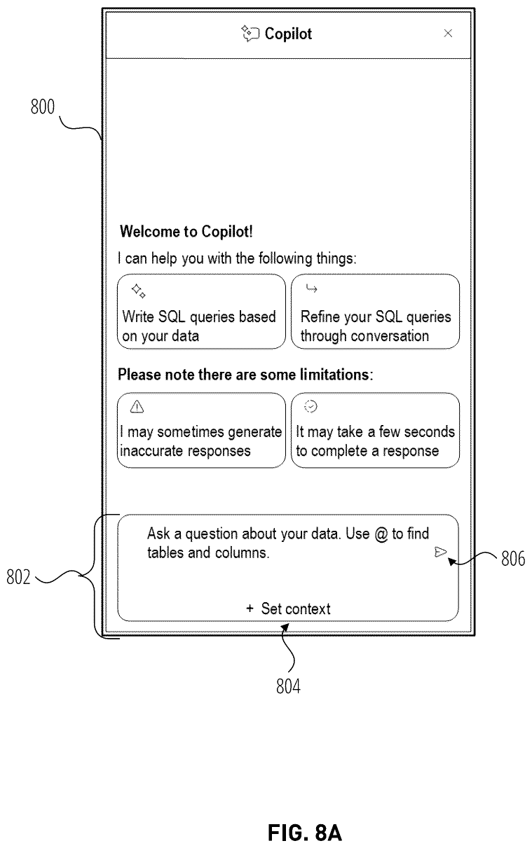

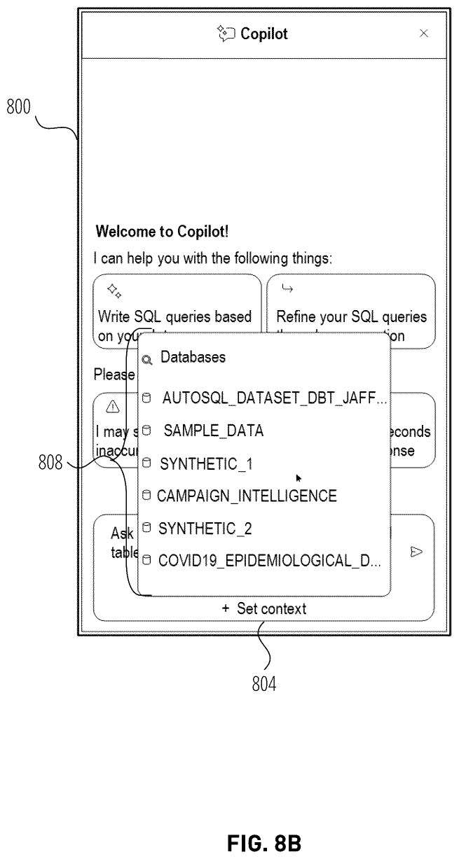

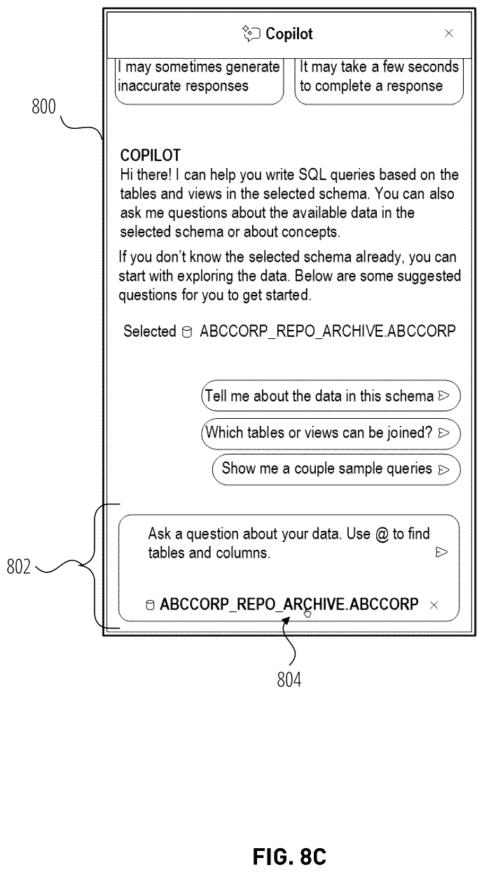

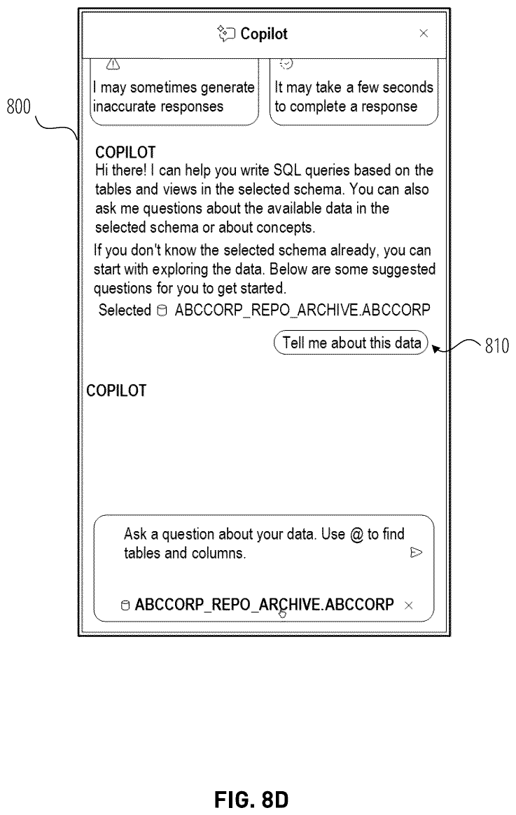

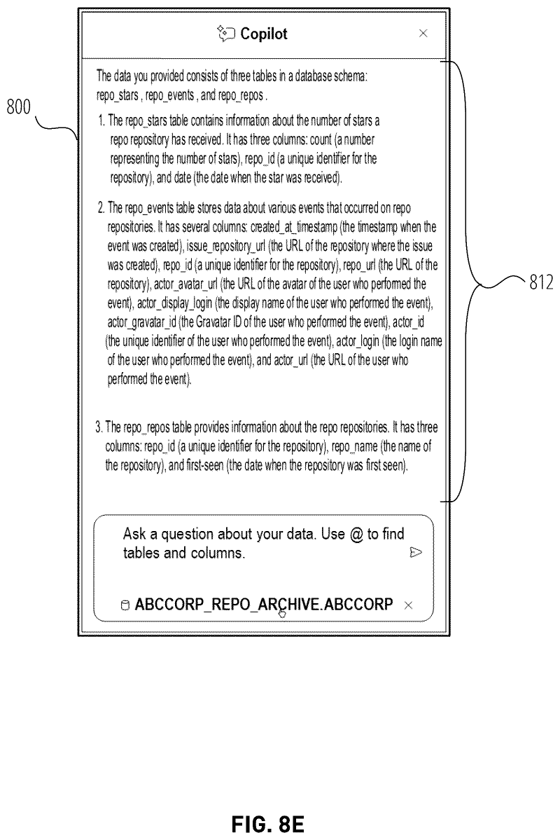

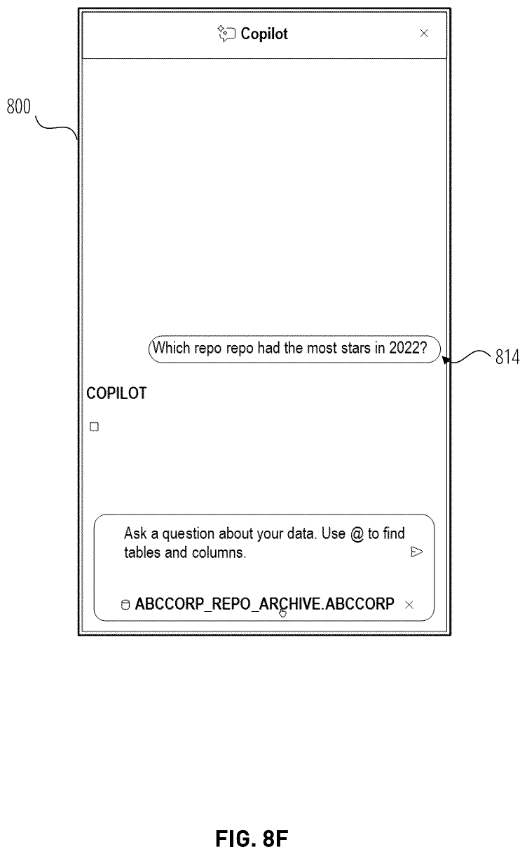

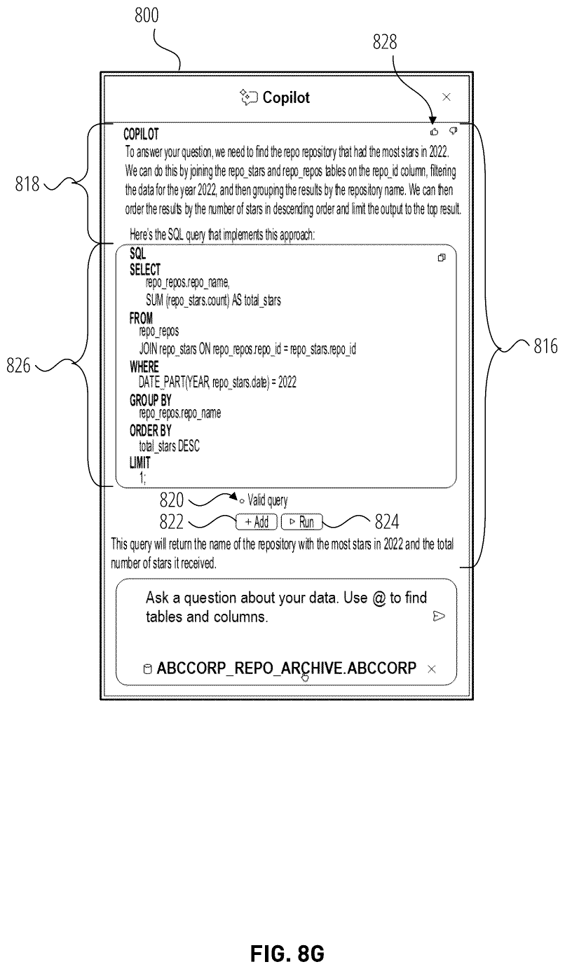

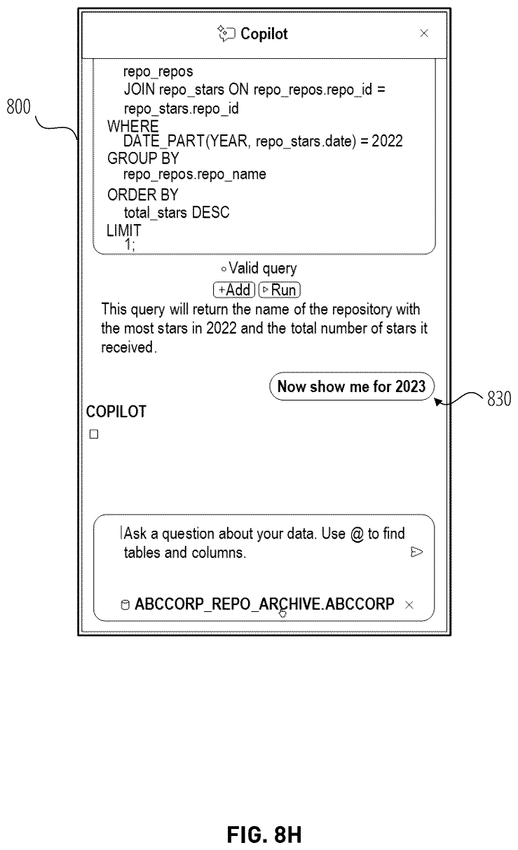

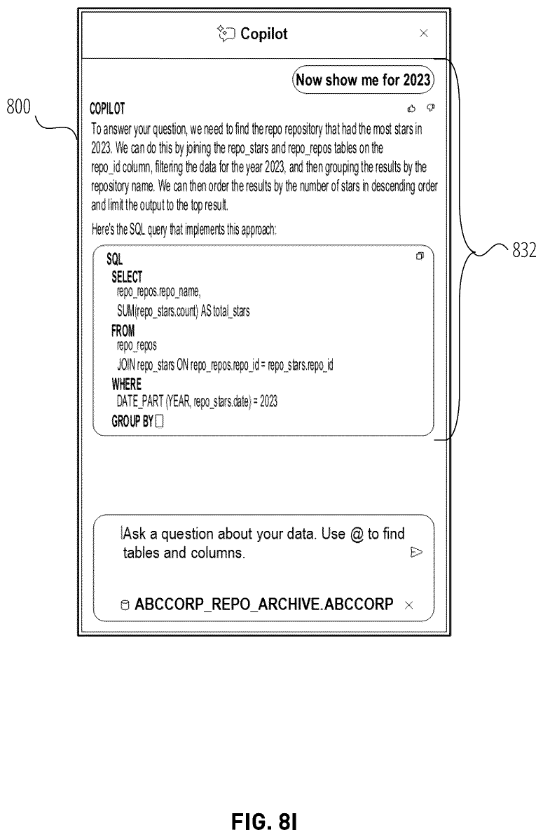

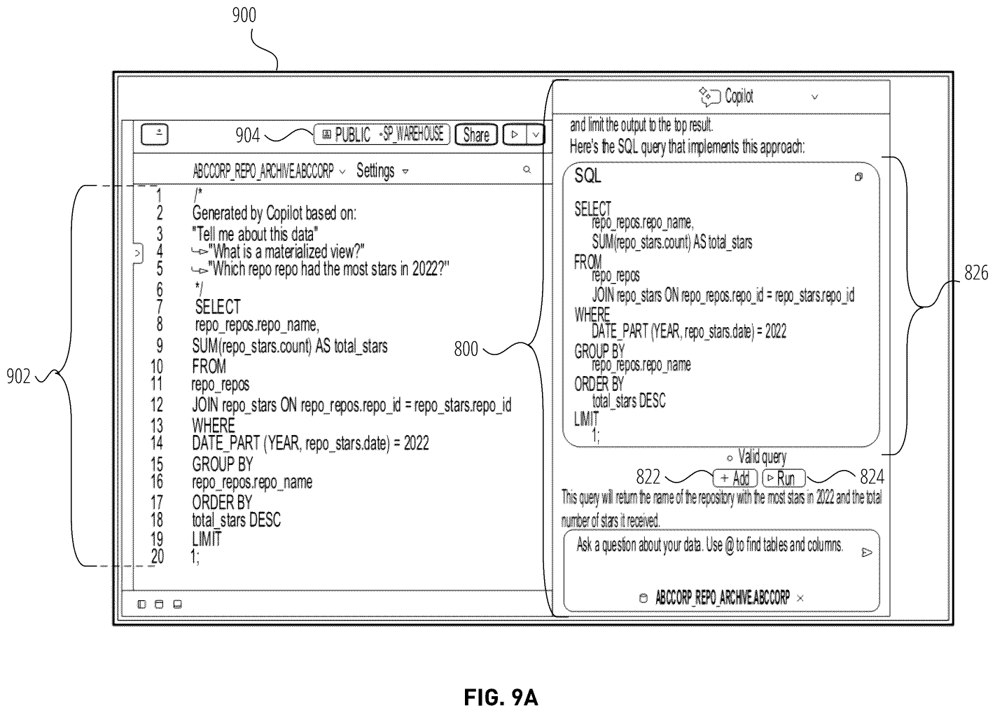

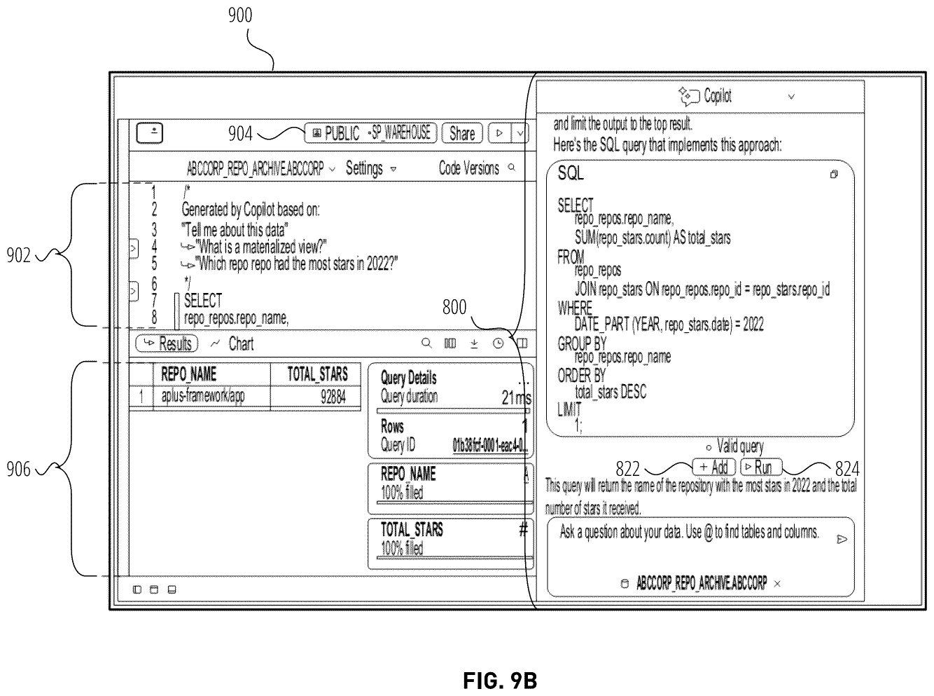

An example of a graphical user interface of an AI-based assistant is illustrated and described with respect to FIG. 8A through FIG. 8I. Additionally, an example of a graphical user interface of an AI-based assistant, displayed in a software application environment, is illustrated and described with respect to FIG. 9A and FIG. 9B.

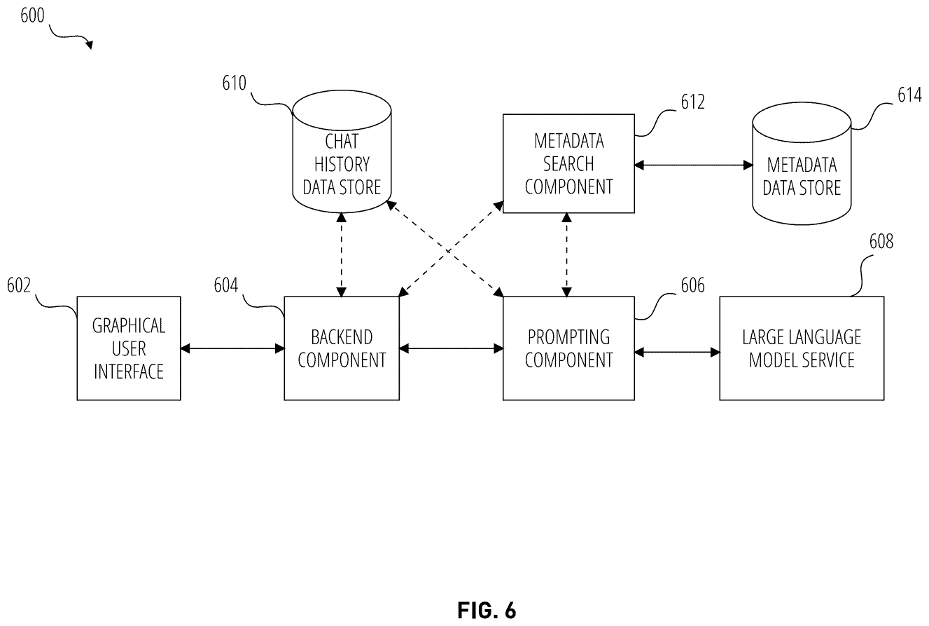

FIG. 6 is a diagram illustrating an example artificial intelligence (AI)-based assistant system 600, according to some embodiments of the present disclosure. According to some embodiments, the AI-based assistant system 600 represents an implementation of method 400 of FIG. 4 or method 500 of FIG. 5. As shown, the AI-based assistant system 600 comprises a graphical user interface 602, a backend component 604, a prompting component 606, a large language model service 608, a chat history data store 610, a metadata search component 612, and a metadata data store 614. The graphical user interface 602 can implement or otherwise support a graphical user interface of an AI-based assistant (an example of which is illustrated and described with respect to FIG. 8A through FIG. 8I). Depending on the embodiment, the graphical user interface of an AI-based assistant can be invoked and displayed as a standalone software application, or can be invoked and displayed within a software application environment (e.g., IDE), which can represent a front-end or downstream software application. The graphical user interface 602 exchanged data with the backend component 604, which can facilitate interactions between a user accessing the graphical user interface 602 and the remainder of the AI-based assistant system 600. During operation of the AI-based assistant system 600, a user can submit a selection of a schema and a natural language request to the AI-based assistant system 600 by way of the graphical user interface 602. The backend component 604 can receive the selection of the schema and the natural language request and, subsequently, the backend component 604, the prompting component 606, or both retrieve chat history data associated with the user from the chat history data store 610. Additionally, the backend component 604, the prompting component 606, or both determine context data as described herein, which can comprise using the metadata search component 612 to search the metadata data store 614 for metadata based on a query string. As described herein, the query string can comprise one or more of user information (e.g., user's role, user's access privileges, user's organization, etc.), a set of text from the chat history data associated with the user and retrieved from the chat history data store 610, and the natural language request. The metadata provided by the metadata search component 612 can represent metadata relevant to responding to the natural language request.

The large language model service 608 can provide the AI-based assistant system 600 with access to one or more large language models. The prompting component 606 uses a set of large language models, accessible through the large language model service 608, to generate a response to the natural language request based on the context data and the natural language request. As described herein, the response can comprise a structured language data query (e.g., SQL) that can be performed on a data store (e.g., database) to obtain a query response or to modify or add stored data to the data store (per the user's natural language request), and a natural language explanation of the structured language data query, where the natural language explanation can explain or detail how the structured language data query operates and what result the structured language data query aims to achieve. Eventually, the response is generated and provided by the large language model service 608, and the response is returned (e.g., displayed) to the user through the graphical user interface 602 (by way of the prompting component 606 and the backend component 604).

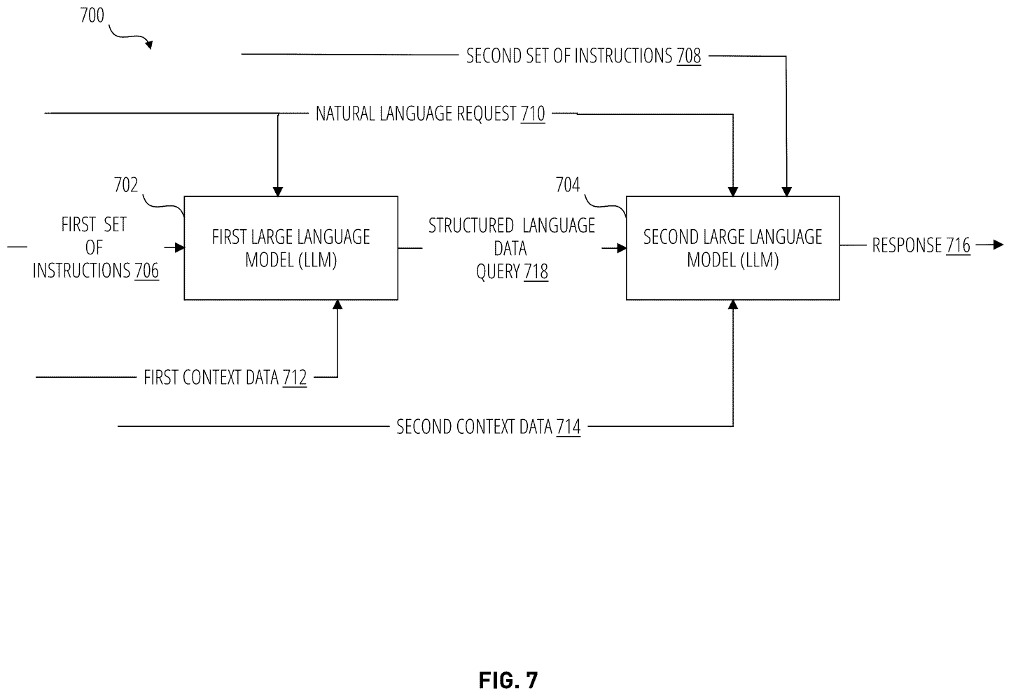

FIG. 7 is a diagram illustrating an example chain of large language models 700, according to some embodiments of the present disclosure. As shown, the chain of large language models 700 comprises a first large language model (LLM) 702 and a second large language model (LLM) 704. Though FIG. 7 illustrates the chain of large language models 700 with two large language models chained together, for some embodiments, three or more large language models are chained together. An output of a large language model in the chain can be received by a next/subsequent large language model in the chain as input, and a last large language model in the chain can generate the response. Each of one or more large language models in the chain can serve a different purpose or functionality. For example, one large language model in the chain can be trained, fine-tuned, or well-suited for natural language processing (NLP), and another can be trained, fine-tuned, or well-suited for generation of structured language data queries.

During operation, the first LLM 702 receives, as input (e.g., prompt input), a first set of instructions 706, a natural language request 710 received from a user, and first context data 712. For some embodiments, the first set of instructions 706 is specifically configured for the first LLM 702. The first set of instructions 706 can facilitate performance of a specific operation or functionality by the first LLM 702, where the specific operation/functionality can comprise generating a structured language data query 718 (e.g., SQL) based on the first context data 712 and the natural language request 710. The first LLM 702 can also be fine-tuned to protect against harmful user natural language requests and harmful user responses. For some embodiments, the first context data 712 is determined specifically to facilitate or support the operation/functionality of the first LLM 702.

During operation, the second LLM 704 receives, as input (e.g., prompt input), a second set of instructions 708, the natural language request 710 received from a user, second context data 714, and the structured language data query 718 generated (as output) by the first LLM 702. For some embodiments, the second set of instructions 708 is specifically configured for the second LLM 704. The second set of instructions 708 can facilitate performance of a specific operation or functionality by the second LLM 704, where the specific operation/functionality can comprise generating a response 716, where the response 716 can comprise the structured language data query 718 (e.g., SQL) and a natural language explanation of the structured language data query 718. For some embodiments, the second context data 714 is determined specifically to facilitate or support the operation/functionality of the first LLM 702.

As noted herein, FIG. 7 represents an example implementation of a chain of large language models. The configuration of the chain of large language models for other embodiments can differ from that of the chain of large language models 700. For instance, though not illustrated in FIG. 7, the chain of large language models can have one or more additional LLMs that are operably coupled to the beginning of the chain of large language models and that classify a user's intent and generate a first set of instructions for the first LLM 702, a second set of instructions for the second LLM 704, or a common set of instructions for the first LLM 702 and the second LLM 704 based on the classified user's intent. Additionally, or alternatively, the chain of large language models can have one or more additional LLMs that are operably coupled to the beginning of the chain of large language models and that identify whether a user's natural language request (e.g., natural language question) is malicious (and, if malicious, cause the chain of large language models and/or the AI-based assistant to decline to respond to the natural language request).

FIG. 8A through FIG. 8I illustrate an example graphical user interface 800 for an artificial intelligence (AI)-based assistant system (or copilot) and example interactions with the example graphical user interface 800, according to some embodiments of the present disclosure. As described herein, the AI-based assistant can used by a user, such as a data analyst or a SQL developer, to accelerate the user's workflow, to improve the user's productivity for different (e.g., coding) tasks, and to facilitate completion of the user's technical task with less technical knowledge than would otherwise be needed.

Referring now to FIG. 8A, the graphical user interface 800 comprises an input field 802 configured to receive a user's natural language request (e.g., natural language question). The graphical user interface 800 comprises a ‘context’ graphical user interface element 804 configured to allow a user to select (or set) a context for the natural language request (and subsequent natural language requests) the user inputs into the input field 802, which can include selection of a schema as part of the context (as shown in FIG. 8B). The graphical user interface 800 also comprises a ‘send’ graphical user interface element 806 configured to cause submission of a natural language request, currently entered in the input field 802, to the AI-based assistant for generation of a response. Referring now to FIG. 8B, upon the user selecting the ‘context’ graphical user interface element 804, a ‘schema selector’ graphical user interface 808 is presented in the graphical user interface 800, which is configured to allow a user to select a schema from a set of schemas. The set of schemas presented (or displayed) in the ‘schema selector’ graphical user interface 808 can represent those that the AI-based assistant has determined to be accessible to the user. As shown in FIG. 8C, after selection (or setting) of the schema, the ‘context’ graphical user interface element 804 can be updated to show the schema currently selected (or set) for use by the AI-based assistant. Referring now to FIG. 8D, after the user enters a natural language request of ‘Tell me about this data’ (via the input field 802 and ‘send’ graphical user interface element 806) with respect to the current context (and the selected schema), a chat history of the graphical user interface 800 shows the natural language request 810.

Turning now to FIG. 8E, the AI-based assistant generates a response based on the natural language request 810, and causes the response to be presented in the graphical user interface 800 as a response 812. As shown, the response 812 includes a natural language explanation (or natural language response) to the natural language request 810. Though not shown in FIG. 8E, the response generated (and presented as the response 812) can include a structured language data query and a natural language explanation of the structured language data query. In FIG. 8F, the graphical user interface 800 shows that the user submitted (via the input field 802 and ‘send’ graphical user interface element 806) another natural language request 814 of ‘Which repo had the most stars in 2022?’ Referring now to FIG. 8G, the AI-based assistant generates a response based on the natural language request 814, and causes the response to be displayed in the graphical user interface 800 as a response 816. As shown, the response 816 comprises a structured language data query 826 (e.g., SQL) and a natural language response 818 of the structured language data query 826.

Continuing with FIG. 8G, the AI-based assistant causes the graphical user interface 800 to present a ‘validity’ graphical user interface element 820, which can indicate whether (or not) the structured language data query 826 is a valid structured language data query. For some embodiments, the AI-based assistant determines whether the structured language data query 826 of the response 816 is valid (or not) using a function or command that generates a query plan for a structured language data query without running the structured language data query, where a successful generation of a query plan is an indication that the structured language data query 826 is valid and an unsuccessful generation of the query plan is an indication that the structured language data query 826 is invalid or non-runnable. The function or command used to generate the query plan can include, for example, an EXPLAIN command.

As also shown in FIG. 8G, the graphical user interface 800 presents a ‘add’ graphical button 822, a ‘run’ graphical button 824, and a ‘feedback’ graphical user interface element 828. For some embodiments, the ‘add’ graphical button 822 is configured to cause, upon selection of the ‘add’ graphical button 822 by the user, insertion of the structured language data query 826 (from the response 816) to a graphical user interface of a software application environment that is external to the graphical user interface 800 of the artificial intelligence-based assistant, where the AI-based assistant is invoked and/or displayed within the software application environment. An example of this is illustrated in, and described with respect to, FIG. 9A. For some embodiments, the ‘run’ graphical button 824 is configured to cause, upon selection of the ‘run’ graphical button 824 by the user, execution of the structured language data query 826 on the data store. Depending on the embodiment, a query result received in response to the execution of the structured language data query 826 can be displayed within the graphical user interface 800, or the query result can be displayed in a graphical user interface of a software application environment that is external to the graphical user interface 800 of the artificial intelligence-based assistant, where the AI-based assistant is invoked and/or displayed within the software application environment. An example of the latter is illustrated in, and described with respect to, FIG. 9B. The ‘feedback’ graphical user interface element 828 can enable a user to provide user feedback with respect to a generated response presented by the AI-based assistant in the graphical user interface 800. For example, if the user is satisfied or approves of a generated response currently presented in the graphical user interface 800, the user can select the thumbs-up graphic of the ‘feedback’ graphical user interface element 828 and, if the user is not satisfied or disapproves of the generated response, the user can select the thumbs-down graphic of the ‘feedback’ graphical user interface element 828. According to some embodiments, the user feedback provided by the ‘feedback’ graphical user interface element 828 can be to train or fine-tune one or more large language models used by the AI-based assistant, or can be used as context data for subsequent responses generated for the user by the AI-based assistant (e.g., in response to subsequent natural language requests submitted by the user).

In FIG. 8H and FIG. 8I, the graphical user interface 800 illustrates a natural language request 830 submitted by the user after the response 812 is presented, and that the AI-based assistant processes using the same context as the natural language request 810 plus the response 812 previously generated. As shown in FIG. 8I, the AI-based assistant generates a response to the natural language request 830 (based on the same context as the natural language request 810 plus the response 812) and presents the response in the graphical user interface 800 as response 832.

FIG. 9A and FIG. 9B illustrate an example graphical user interface 800 for an artificial intelligence (AI)-based assistant system presented (or displayed) within another graphical user interface 900 for a software application environment, according to some embodiments of the present disclosure. The software application environment can be that of a downstream or front-end software application, such as a data worksheet software application, data notebook software application, or an IDE. For some embodiments, the graphical user interface 800 is opened (or invoked) within the graphical user interface 900 via a graphical user interface element (not shown).

Referring now to FIG. 9A, based on the user selecting the ‘add’ graphical button 822, a version of the structured language data query 826 (e.g., the structured language data query 826 with additional commentary) is inserted into a context (e.g., graphical user interface input field) within the graphical user interface 900 as inserted structured language data query 902. The context into which the inserted structured language data query 902 is inserted can include, for example, a currently open (or new) data worksheet, data notebook, or source code file. As shown in FIG. 9A, the graphical user interface 900 presents a ‘data store’ graphical user interface element 904 that enables a user to select a data store (e.g., database) on which the user intends to run the inserted structured language data query 902.

Referring now to FIG. 9B, based on the user selecting the ‘run’ graphical button 824, a version of the structured language data query 826 is inserted into a context within the graphical user interface 900 as inserted structured language data query 902, and executed on the data store (e.g., database) selected by the user via the ‘data store’ graphical user interface element 904. Subsequently, a query result received from executing the inserted structured language data query 902 (on the data store indicated by the ‘data store’ graphical user interface element 904) is displayed in the graphical user interface 900 as a query result 906. The query result 906 can comprise some portion of raw content provided by the query result, and can comprise one or more graphical elements (e.g., graphical table) that represent the query result and/or metrics of executing the inserted structured language data query 902.

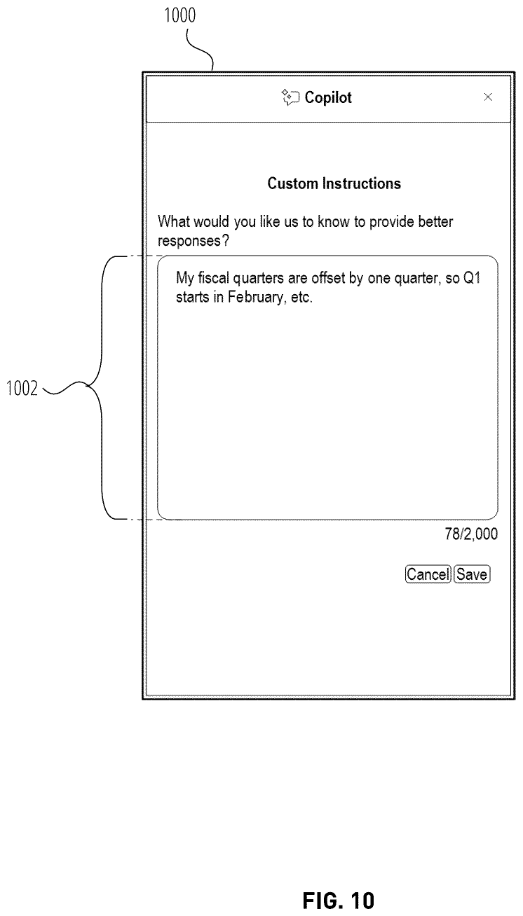

FIG. 10 illustrates an example graphical user interface 1000 for receiving customer instructions, according to some embodiments of the present disclosure. For some embodiments, the graphical user interface 1000 comprises an input field 1002 configured to receive a set of custom or pre-instructions from a user, which can be used to form part of the context data used by an AI-based assistant as described herein.

FIG. 11 illustrates a diagrammatic representation of a machine 1100 in the form of a computer system within which a set of instructions can be executed for causing the machine 1100 to perform any one or more of the methodologies discussed herein, according to an example embodiment. Specifically, FIG. 11 shows a diagrammatic representation of the machine 1100 in the example form of a computer system, within which instructions 1110 (e.g., software, a program, an application, an applet, an app, or other executable code) for causing the machine 1100 to perform any one or more of the methodologies discussed herein can be executed. For example, the instructions 1110 may cause the machine 1100 to execute any one or more operations of any one or more of the methods described herein. As another example, the instructions 1110 may cause the machine 1100 to implement portions of the data flows described herein. In this way, the instructions 1110 transform a general, non-programmed machine into a particular machine 1100 (e.g., the compute service manager 106, the execution platform 108, client device 112) that is specially configured to carry out any one of the described and illustrated functions in the manner described herein.

In alternative embodiments, the machine 1100 operates as a standalone device or can be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1110, sequentially or otherwise, that specify actions to be taken by the machine 1100. Further, while only a single machine 1100 is illustrated, the term “machine” shall also be taken to include a collection of machines machine 1100 that individually or jointly execute the instructions 1110 to perform any one or more of the methodologies discussed herein.

The machine 1100 includes processors 1104, memory 1112, and input/output (I/O) components 1122 configured to communicate with each other such as via a bus 1102. In an example embodiment, the processors 1104 (e.g., a central processing unit (CPU), a reduced instruction set computing (RISC) processor, a complex instruction set computing (CISC) processor, a graphics processing unit (GPU), a digital signal processor (DSP), an application- specific integrated circuit (ASIC), a radio-frequency integrated circuit (RFIC), another processor, or any suitable combination thereof) may include, for example, a processor 1106 and a processor 1108 that may execute the instructions 1110. The term “processor” is intended to include multi-core processors 1104 that may comprise two or more independent processors (sometimes referred to as “cores”) that may execute instructions 1110 contemporaneously. Although FIG. 11 shows multiple processors 1104, the machine 1100 may include a single processor with a single core, a single processor with multiple cores (e.g., a multi-core processor), multiple processors with a single core, multiple processors with multiple cores, or any combination thereof.

The memory 1112 may include a main memory 1114, a static memory 1116, and a storage unit 1118, all accessible to the processors 1104 such as via the bus 1102. The main memory 1114, the static memory 1116, and the storage unit 1118 comprising a machine storage medium 1120 may store the instructions 1110 embodying any one or more of the methodologies or functions described herein. The instructions 1110 may also reside, completely or partially, within the main memory 1114, within the static memory 1116, within the storage unit 1118, within at least one of the processors 1104 (e.g., within the processor's cache memory), or any suitable combination thereof, during execution thereof by the machine 1100.

The I/O components 1122 include components to receive input, provide output, produce output, transmit information, exchange information, capture measurements, and so on. The specific I/O components 1122 that are included in a particular machine 1100 will depend on the type of machine. For example, portable machines such as mobile phones will likely include a touch input device or other such input mechanisms, while a headless server machine will likely not include such a touch input device. It will be appreciated that the I/O components 1122 may include many other components that are not shown in FIG. 11. The I/O components 1122 are grouped according to functionality merely for simplifying the following discussion and the grouping is in no way limiting. In various example embodiments, the I/O components 1122 may include output components 1124 and input components 1126. The output components 1124 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1126 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication can be implemented using a wide variety of technologies. The I/O components 1122 may include communication components 1128 operable to couple the machine 1100 to a network 1132 via a coupling 1136 or to devices 1130 via a coupling 1134. For example, the communication components 1128 may include a network interface component or another suitable device to interface with the network 1132. In further examples, the communication components 1128 may include wired communication components, wireless communication components, cellular communication components, and other communication components to provide communication via other modalities. The devices 1130 can be another machine or any of a wide variety of peripheral devices (e.g., a peripheral device coupled via a universal serial bus (USB)). For example, as noted above, the machine 1100 may correspond to any client device, the compute service manager 106, the execution platform 108, and the devices 1130 may include any other of these systems and devices.

The various memories (e.g., 1112, 1114, 1116, and/or memory of the processor(s) 1104 and/or the storage unit 1118) may store one or more sets of instructions 1110 and data structures (e.g., software) embodying or utilized by any one or more of the methodologies or functions described herein. These instructions 1110, when executed by the processor(s) 1104, cause various operations to implement the disclosed embodiments.

As used herein, the terms “machine-storage medium,” “device-storage medium,” and “computer-storage medium” mean the same thing and can be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1132 can be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1132 or a portion of the network 1132 may include a wireless or cellular network, and the coupling 1136 can be a Code Division Multiple Access (CDMA) connection, a Global System for Mobile communications (GSM) connection, or another type of cellular or wireless coupling. In this example, the coupling 1136 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1110 can be transmitted or received over the network 1132 using a transmission medium via a network interface device (e.g., a network interface component included in the communication components 1128) and utilizing any one of a number of well-known transfer protocols (e.g., hypertext transfer protocol (HTTP)). Similarly, the instructions 1110 can be transmitted or received using a transmission medium via the coupling 1134 (e.g., a peer-to-peer coupling) to the devices 1130. The terms “transmission medium” and “signal medium” mean the same thing and can be used interchangeably in this disclosure. The terms “transmission medium” and “signal medium” shall be taken to include any intangible medium that is capable of storing, encoding, or carrying the instructions 1110 for execution by the machine 1100, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some embodiments, the processor or processors may be located in a single location (e.g., within a home environment, an office environment, or a server farm), while in other embodiments the processors may be distributed across several locations.

Described implementations of the subject matter can include one or more features, alone or in combination as illustrated below by way of examples.

Example 1 is a system comprising: at least one hardware processor; and at least one memory storing instructions that cause the at least one hardware processor to perform operations comprising: receiving, in association with a user, a selection of a schema and a natural language request; determining context data for responding to the natural language request, the context data comprising metadata associated with the schema; and using a set of large language models to generate a response to the natural language request based on the context data and the natural language request, the response comprising: a structured language data query for a data store; and a natural language explanation of the structured language data query.

In Example 2, the subject matter of Example 1 includes, wherein the determining of the context data for responding to the natural language request comprises: performing a search, on a metadata data store, for the metadata associated with the schema, the search being performed using a query string that comprises the natural language request; and receiving a result to the search, the result comprising the metadata.

In Example 3, the subject matter of Example 2 includes, wherein the context data comprises a set of text from chat history data associated with the user.

In Example 4, the subject matter of Examples 2-3 includes, wherein the query string comprises information regarding the user.

In Example 5, the subject matter of Examples 2-4 includes, wherein the metadata comprises information regarding at least one of: the data store; one or more tables on the data store and relevant to the query string; one or more columns on the data store and relevant to the query string; or one or more views on the data store and relevant to the query string.

In Example 6, the subject matter of Example 5 includes, wherein the context data comprises at least one of: a first set of sample values for the one or more columns; a second set of sample values for a first set of columns of the one or more tables; or a third set of sample values for a second set of columns of the one or more views.

In Example 7, the subject matter of Examples 2-6 includes, wherein the metadata comprises a set of comments associated with at least one table, column, or view relevant to the query string.

In Example 8, the subject matter of Examples 2-7 includes, wherein the metadata comprises a set of tags associated with at least one table, column, or view relevant to the query string.

In Example 9, the subject matter of Examples 1-8 includes, wherein the context data comprises information from at least one of: user feedback data associated with the user; or a structured language data query history associated with the user.

In Example 10, the subject matter of Examples 1-9 includes, wherein the context data comprises information from verified query repository data, the verified query repository data comprising one or more individual structured language queries paired with natural language descriptions of the one or more individual structured language queries.

In Example 11, the subject matter of Examples 1-10 includes, wherein the context data comprises one or more pre-instructions provided by the user.

In Example 12, the subject matter of Examples 1-11 includes, wherein the operations comprise: causing presentation of a graphical user interface for an artificial intelligence-based assistant, the selection of the schema being received from the user by the graphical user interface, the natural language request being received from the user by the graphical user interface.

In Example 13, the subject matter of Example 12 includes, wherein the graphical user interface for the artificial intelligence-based assistant is presented within a software application environment, and wherein the context data comprises information regarding a current context of the software application environment.

In Example 14, the subject matter of Examples 12-13 includes, wherein the operations comprise: determining a set of accessible schemas accessible to the user; and providing the set of accessible schemas for selection by the user via the graphical user interface, the selection of the schema being selected from the set of accessible schemas.

In Example 15, the subject matter of Examples 12-14 includes, wherein the operations comprise: causing presentation of the response in the graphical user interface; and causing presentation of a graphical user interface element in the graphical user interface, the graphical user interface element being configured to cause, upon selection of the graphical user interface element by the user: execution of the structured language data query on the data store; and display of a query result in the graphical user interface for the artificial intelligence-based assistant, the query result being received in response to the execution of the structured language data query.

In Example 16, the subject matter of Examples 12-15 includes, wherein the graphical user interface for the artificial intelligence-based assistant is presented as a first graphical user interface within a software application environment, and wherein the operations comprise: causing presentation of the response in the first graphical user interface; and causing presentation of a graphical user interface element in the first graphical user interface, graphical user interface element being configured to cause, upon selection of the graphical user interface element by the user, insertion of the structured language data query from the response to a second graphical user interface of the software application environment that is external to the first graphical user interface of the artificial intelligence-based assistant.

In Example 17, the subject matter of Examples 12-16 includes, wherein the graphical user interface for the artificial intelligence-based assistant is presented as a first graphical user interface within a software application environment, and wherein the operations comprise: causing presentation of the response in the first graphical user interface; and causing presentation of a graphical user interface element in the first graphical user interface that is configured to cause, upon selection of the graphical user interface element by the user: execution of the structured language data query on the data store; and display of a query result in a second graphical user interface of the software application environment that is external to the first graphical user interface of the artificial intelligence-based assistant, the query result being received in response to the execution of the structured language data query.

In Example 18, the subject matter of Examples 1-17 includes, wherein the set of large language models comprises a chain of large language models, wherein a first large language model of the chain of large language models generates a first output based on a first input that comprises the natural language request and the context data, and wherein a second large language model of the chain of large language models generates a second output based on a second input that comprises the natural language request and the first output from the first large language model.

Example 19 is a method to implement of any of Examples 1-18.

Example 20 is a machine-storage medium, the machine-storage medium including instructions that when executed by a machine, cause the machine to perform operations to implement of any of Examples 1-18.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

1. A system comprising:
at least one hardware processor; and
at least one memory storing instructions that cause the at least one hardware processor to perform operations comprising:
causing presentation of a graphical user interface for an artificial intelligence-based assistant;
receiving from a user, by the graphical user interface, a selection of a schema and a natural language request, the schema being associated with a select data store;
determining context data for responding to the natural language request, the context data comprising metadata associated with the schema;
using a set of large language models to generate a response to the natural language request based on the context data and the natural language request, the response comprising:
a structured language data query for the select data store; and
a natural language explanation of the structured language data query; and
causing presentation of the response in the graphical user interface without executing the structured language data query in the response.

2. The system of claim 1, wherein the determining of the context data for responding to the natural language request comprises:
performing a search, on a metadata data store, for the metadata associated with the schema, the search being performed using a query string that comprises the natural language request; and
receiving a result to the search, the result comprising the metadata.

3. The system of claim 2, wherein the context data comprises a set of text from chat history data associated with the user.

4. The system of claim 2, wherein the query string comprises information regarding the user.

5. The system of claim 2, wherein the metadata comprises information regarding at least one of:
the select data store;
one or more tables on the select data store and relevant to the query string;
one or more columns on the select data store and relevant to the query string; or
one or more views on the select data store and relevant to the query string.

6. The system of claim 5, wherein the context data comprises at least one of:
a first set of sample values for the one or more columns;
a second set of sample values for a first set of columns of the one or more tables; or
a third set of sample values for a second set of columns of the one or more views.

7. The system of claim 2, wherein the metadata comprises a set of comments associated with at least one table, column, or view relevant to the query string.

8. The system of claim 2, wherein the metadata comprises a set of tags associated with at least one table, column, or view relevant to the query string.

9. The system of claim 1, wherein the context data comprises information from at least one of:
user feedback data associated with the user; or
a structured language data query history associated with the user.

10. The system of claim 1, wherein the context data comprises information from verified query repository data, the verified query repository data comprising one or more individual structured language queries paired with natural language descriptions of the one or more individual structured language queries.

11. The system of claim 1, wherein the context data comprises one or more pre-instructions provided by the user.

12. The system of claim 1,
wherein the natural language request is received from the user by the graphical user interface.

13. The system of claim 12, wherein the graphical user interface for the artificial intelligence-based assistant is presented within a software application environment, and wherein the context data comprises information regarding a current context of the software application environment.

14. The system of claim 12, wherein the operations comprise:
determining a set of accessible schemas accessible to the user; and
providing the set of accessible schemas for selection by the user via the graphical user interface, the selection of the schema being selected from the set of accessible schemas.

15. The system of claim 12, wherein the operations comprise:
causing presentation of a graphical user interface element in the graphical user interface, the graphical user interface element being configured to cause, upon selection of the graphical user interface element by the user:
execution of the structured language data query on the select data store; and
display of a query result in the graphical user interface for the artificial intelligence-based assistant, the query result being received in response to the execution of the structured language data query.

16. The system of claim 12, wherein the graphical user interface for the artificial intelligence-based assistant is presented as a first graphical user interface within a software application environment, and wherein the operations comprise:
causing presentation of a graphical user interface element in the first graphical user interface, graphical user interface element being configured to cause, upon selection of the graphical user interface element by the user, insertion of the structured language data query from the response to a second graphical user interface of the software application environment that is external to the first graphical user interface of the artificial intelligence-based assistant.

17. The system of claim 12, wherein the graphical user interface for the artificial intelligence-based assistant is presented as a first graphical user interface within a software application environment, and wherein the operations comprise:
causing presentation of a graphical user interface element in the first graphical user interface that is configured to cause, upon selection of the graphical user interface element by the user:
execution of the structured language data query on the select data store; and
display of a query result in a second graphical user interface of the software application environment that is external to the first graphical user interface of the artificial intelligence-based assistant, the query result being received in response to the execution of the structured language data query.

18. The system of claim 1, wherein the set of large language models comprises a chain of large language models, wherein a first large language model of the chain of large language models generates a first output based on a first input that comprises the natural language request and the context data, and wherein a second large language model of the chain of large language models generates a second output based on a second input that comprises the natural language request and the first output from the first large language model.

19. A method comprising:
causing, by a hardware processor, presentation of a graphical user interface for an artificial intelligence-based assistant;
receiving from a user, by the graphical user interface and the hardware processor, a selection of a schema and a natural language request, the schema being associated with a select data store;
determining, by the hardware processor, context data for responding to the natural language request, the context data comprising metadata associated with the schema;
using, by the hardware processor, a set of large language models to generate a response to the natural language request based on the context data and the natural language request, the response comprising:
a structured language data query for the select data store; and
a natural language explanation of the structured language data query; and
causing presentation of the response in the graphical user interface without executing the structured language data query in the response.

20. The method of claim 19, wherein the determining of the context data for responding to the natural language request comprises:
performing a search, on a metadata data store, for the metadata associated with the schema, the search being performed using a query string that comprises the natural language request; and
receiving a result to the search, the result comprising the metadata.

21. The method of claim 20, wherein the context data comprises a set of text from chat history data associated with the user.

22. The method of claim 20, wherein the query string comprises information regarding the user.

23. The method of claim 20, wherein the metadata comprises information regarding at least one of:
the select data store;
one or more tables on the select data store and relevant to the query string;
one or more columns on the select data store and relevant to the query string; or
one or more views on the select data store and relevant to the query string.

24. The method of claim 23, wherein the context data comprises at least one of:
a first set of sample values for the one or more columns;
a second set of sample values for a first set of columns of the one or more tables; or
a third set of sample values for a second set of columns of the one or more views.

25. The method of claim 20, wherein the metadata comprises a set of comments associated with at least one table, column, or view relevant to the query string.

26. The method of claim 20, wherein the metadata comprises a set of tags associated with at least one table, column, or view relevant to the query string.

27. The method of claim 19, wherein the context data comprises information from at least one of:
user feedback data associated with the user; or
a structured language data query history associated with the user.

28. The method of claim 19, wherein the context data comprises information from verified query repository data, the verified query repository data comprising one or more individual structured language queries paired with natural language descriptions of the one or more individual structured language queries.

29. The method of claim 19, wherein the context data comprises one or more pre-instructions provided by the user.

30. A machine-readable storage medium, the machine-readable storage medium including instructions that when executed by a machine, cause the machine to perform operations comprising:
causing presentation of a graphical user interface for an artificial intelligence-based assistant;
receiving from a user, by the graphical user interface, a selection of a schema and a natural language request, the schema being associated with a select data store;
determining context data for responding to the natural language request, the context data comprising metadata associated with the schema;
using a set of large language models to generate a response to the natural language request based on the context data and the natural language request, the response comprising:
a structured language data query for the select data store; and
a natural language explanation of the structured language data query; and
causing presentation of the response in the graphical user interface without executing the structured language data query in the response.
